(19) United States
(12) Patent Application Publication
(10) Pub. No.: US 2007/0018959 A1
(43) Pub. Date: Jan. 25, 2007

(54) Mouse interface system capable of providing thermal feedback

(75) Inventors: Dong Soo Kwon, Yuseong-gu (KR); Gi Hun Yang, Gongju-si (KR)

Correspondence Address: John M. Janeway;GRAYBEAL JACKSON HALEY LLP, Suite 350, 155-108th Avenue NE, Bellevue, WA, 98004-5973, US

(73) Assignee: Korea Advanced Institute of Science and Technology

(21) Appl. No.: 11/365,104

(22) Filed: Feb. 28, 2006

(30) Foreign Application Priority Data
Jul. 22, 2005 (KR) 10-2005-66528

(51) Int. Cl. G09G 5/08

(52) U.S. Cl. 345/163

(57) ABSTRACT

A computer mouse interface system has a mouse section which includes a tactile feedback section arranged to stimulate a finger of a user through a plurality of pins, so that the user can feel the nature of a virtual object displayed on a computer screen. The system further has a thermal feedback section arranged on a side of the mouse section to provide thermal information of the virtual object to the finger of the user. The thermal feedback section comprises a thermoelement for discharging or absorbing heat in response to a control signal according to a temperature variation when a users finger is contact with the virtual object, a cover brought into contact with a surface of the thermoelement to receive heat from the thermoelement, and a cooler brought into contact with another surface of the thermoelement to absorb heat discharged from the thermoelement.

### BACKGROUND OF THE INVENTION

1. Field of the Invention

The present invention relates, in general, to a mouse interface system configured to allow a computer user to feel the nature of a virtual object displayed on a computer screen, and, more particularly, to a mouse interface system capable of providing thermal feedback, which can provide not only tactile information, but also thermal information of a virtual object displayed on a computer screen.

2. Description of the Prior Art

As is generally known in the art, a computer user experiences virtual objects in “virtual reality” games, simulations, etc. displayed on a computer screen. Interface devices for interfacing a user with a computer include a mouse, a joystick, a trackball, a tablet, etc. These interface devices function to directly input control signals or instructions on the computer screen or allow the user to physically experience virtual objects. Therefore, the interface devices require a user-friendly mouse system that allows the user to directly feel the nature of the virtual objects.

FIG. 1 is a perspective view illustrating a mouse interface device for providing force feedback to a user according to the conventional art.

The conventional mouse interface device as shown in FIG. 1 is disclosed in U.S. Pat. No. 6,191,774 entitled “Mouse interface for providing force feedback.” In this mouse interface device, which is connected to a host computer, a force generation section 30 drives a link section 20 to allow a user to experience the feelings of a virtual object displayed on a computer screen, and as a result, force feedback is provided to the finger of a user grasping a mouse section 10.

However, in the conventional mouse interface device, since the force feedback provided to the mouse section 10 allows the user to only indirectly experience tactile information of the virtual object, it is impossible to provide not only various mechanical information including size, weight, shape and hardness of the virtual object, but also the thermal information of the virtual object.

Further, U.S. Pat. Nos. 5,912,660 and 6,278,441 also respectively disclose mouse interface devices configured to allow a user to experience the sensation of touching a virtual object displayed on a computer screen. Nevertheless, in these mouse interface devices, because force feedback is provided through pin-shaped elements, limitations necessarily exist in providing kinesthetic information (obtained when grazing the virtual object), and it is impossible to provide thermal feedback to the user.

Moreover, Korean Patent Application No. 2003-73554 filed in the name of the present applicant discloses a mouse interface system for providing kinesthetic and tactile feedback to the finger of a user. Nonetheless, this mouse interface system cannot properly provide thermal information, that is, the thermal feedback of a virtual object to the finger of the user.

### SUMMARY OF THE INVENTION

Accordingly, the present invention has been made keeping in mind the above problems occurring in the prior art, and an object of the present invention is to provide a mouse interface system for a computer which can not only provide tactile information such as pressure distribution, vibration and a feeling of grazing a virtual object to the finger of a user through a tactile feedback section, but also provide the thermal information of the virtual object to the finger of the user through a thermal feedback section.

In order to achieve the above object, according to the present invention, there is provided a computer mouse interface system having a mouse section which includes a tactile feedback section arranged to stimulate a finger of a user through a plurality of pins so that the user can feel the nature of a virtual object displayed on a computer screen. The computer mouse interface system further has a thermal feedback section arranged on a side of the mouse section to provide thermal information of the virtual object to the finger of the user. The thermal feedback section comprises a thermoelement for discharging or absorbing heat in response to a control signal according to a temperature variation when a user's finger is contacted with the virtual object, a cover brought into contact with a surface of the thermoelement to receive heat from the thermoelement, and a cooler brought into contact with another surface of the thermoelement to absorb heat discharged from the thermoelement.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view illustrating a mouse interface device for providing force feedback to a user according to the conventional art;

FIG. 2 is a partially enlarged perspective view illustrating a mouse interface system capable of providing thermal feedback in accordance with an embodiment of the present invention, which is configured to allow a user to feel thermal feedback from a virtual object displayed on a computer screen;

FIGS. 3a and 3b are an exploded perspective view and an assembled perspective view illustrating a thermal feedback section for providing thermal feedback from the virtual object in the mouse interface system shown in FIG. 2;

FIGS. 4(a) and 4(b) are perspective views illustrating a cover of the thermal feedback section shown in FIG. 3b, which cover is contacted by the finger of a user to provide thermal feedback to the user;

FIG. 5 is a perspective view illustrating a state in which the thermal feedback section shown in FIG. 3b is assembled with a tactile feedback section; and

FIG. 6 is a view illustrating an in-use state of the mouse interface system shown in FIG. 2.

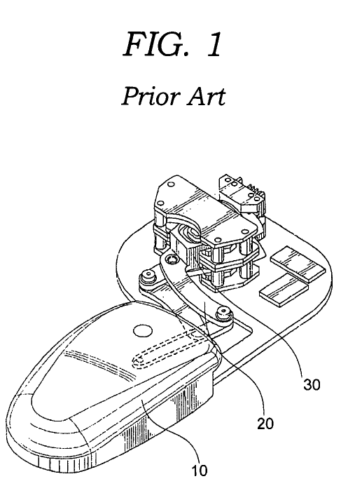

### DETAILED DESCRIPTION OF THE INVENTION

Reference will now be made in greater detail to a preferred embodiment of a mouse interface system capable of providing thermal feedback according to the invention, an example of which is illustrated in the accompanying drawings. Wherever possible, the same reference numerals will be used throughout the drawings and the description to refer to the same or like parts.

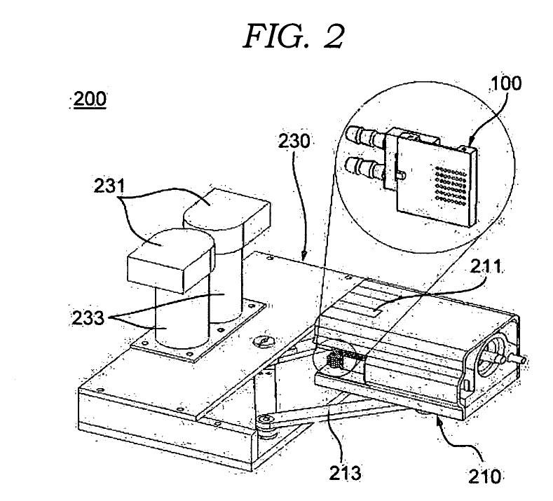

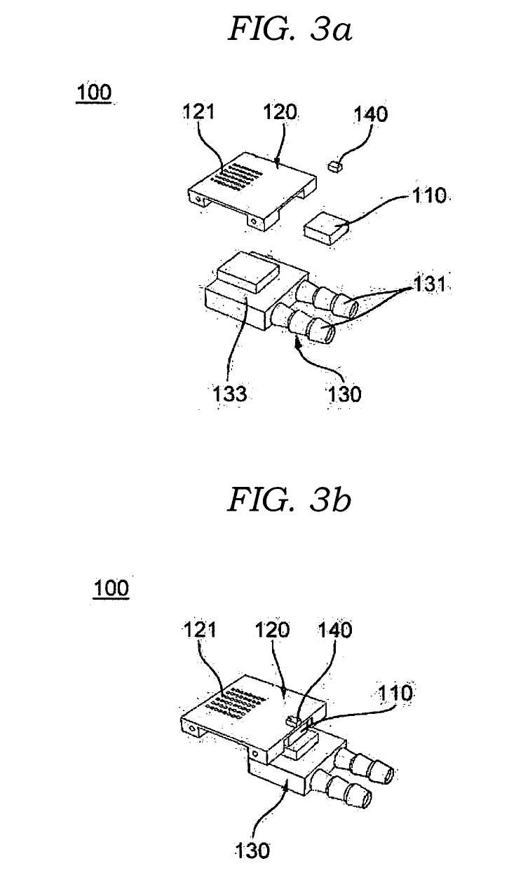

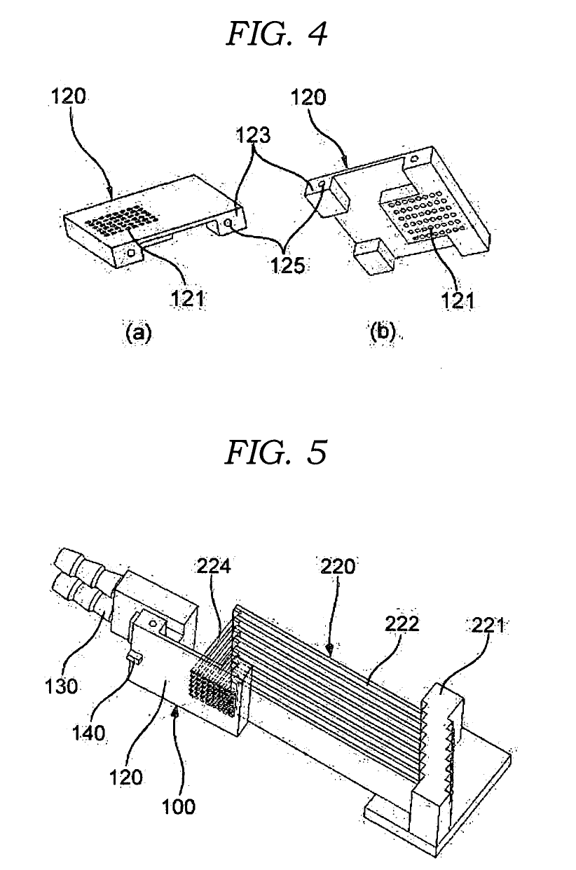

FIG. 2 is a partially enlarged perspective view illustrating a mouse interface system capable of providing thermal feedback, in accordance with an embodiment of the present invention, which is configured to allow a user to feel thermal feedback from a virtual object displayed on a computer screen; FIGS. 3a and 3b are an exploded perspective view and an assembled perspective view illustrating a thermal feedback section for providing thermal feedback from the virtual object in the mouse interface system shown in FIG. 2; FIGS. 4(a) and 4(b) are perspective views illustrating a cover of the thermal feedback section shown in FIG. 3b, which cover is contacted by the finger of a user to provide thermal feedback to the user; and FIG. 5 is a perspective view illustrating a state in which the thermal feedback section shown in FIG. 3b is assembled with a tactile feedback section.

As shown in FIGS. 2 through 5, in a mouse interface system 200 in accordance with an embodiment of the present invention, a mouse section 210 includes a tactile feedback section 220 and a thermal feedback section 100. In the tactile feedback section 220, a plurality of pins 224 organically operate to provide kinesthetic and tactile information of a virtual object displayed on a computer screen to the finger of a user, and the thermal feedback section 100 provides the thermal information of the virtual object displayed on the computer screen to the finger of the user.

The thermal feedback section 100 includes a thermoelement 110, a cover 120, a cooler 130 and a temperature sensor 140. First, the thermoelement 110 of the thermal feedback section 100 serves as a kind of heat pump. The thermoelement 110 is fabricated such that, when a current is supplied from an external power supply in one direction, the thermoelement 110 absorbs heat from one surface thereof and discharges heat from another surface thereof. That is to say, in the thermoelement 110, if one surface serves as a cooling surface, another surface serves as a heating surface. If a current direction is reversed, the cooling surface and the heating surface are also reversed in their functionalities. In the thermal feedback section 100 according to this embodiment of the present invention, while only one thermoelement 110 is illustrated in the drawings, a person having ordinary skill in the art will readily appreciate that two or more thermoelements 110 may be used as occasion demands. In the event that multiple thermoelements 110 are arranged in the thermal feedback section 100, it is possible to vary the temperature distribution over a predetermined area.

The cover 120 has one surface which is contacted by the finger of a user and another surface upon which the thermoelement 110 and the pins 224 of the tactile feedback section 220 are positioned. In the thermal feedback section 100 according to the present invention, heat transfer occurs from the thermoelement 110 attached to the other surface of the cover 120 to the cover 120. Accordingly, in order to ensure that the user is provided with thermal feedback in a quick and exact manner, the cover 120 is formed to have a thickness which is as thin as possible, on and around a region where the cover 120 is brought into contact with the thermoelement 110. In order to fasten the thermal feedback section 100, the cover 120 is coupled to the mouse section 210. To this end, the corner portions 123 of the cover 120 project from the other surface of the cover 120 to have a thickness no less than a predetermined thickness, and are respectively defined with locking grooves 125. A plurality of pin holes 121 are defined through the cover 120 such that the pins 224 of the tactile feedback section 220 are respectively inserted into the pin holes 121. At this time, the portion of the cover 120 through which the pin holes 121 are defined is formed to have a thickness no less than a predetermined thickness to thereby properly guide the linear movement of the pins 224.

The cooler 130 is installed to absorb the heat discharged from the thermnoelement 110 when the heating surface of the thermoelement 110 faces not the cover 120, but the inside of the thermal feedback section 100. The cooler 130 is composed of entrance and exit pipes 131 which define inlet and outlet passages for cooling water and a cooler body 133 which is brought into surface contact with the thermoelement 110 and accommodates cooling water therein. While any type of coolers capable of performing a cooling function may be used as the cooler 130 according to the present invention, a water-cooling type cooler 130 having excellent cooling capability is adopted in this embodiment of the present invention. However, a person having ordinary knowledge in the art will readily understand that an air-cooling type cooler may be adopted as occasion demands.

The temperature sensor 140 is attached to the cover 120 on a pre-selected point to sense the temperature of a portion of the cover 120, which portion is contacted by the finger of the user. The reason for this is that, while the thermoelement 110 is operated in compliance with a calculation result input from a control section, the calculation result input may be different from the actual temperature of the cover 120 depending upon environmental conditions (for example, including heat conductivity of and a specific heat difference on the cover 120, etc.), and therefore, in the present invention, the actual temperature of the cover 120 which is perceived by the user is sensed by the temperature sensor 140 and is used in controlling the temperature of the thermoelement 110.

In the thermal feedback section 100, as shown in FIG. 5, the pins 224 of the tactile feedback section 220 are respectively inserted through the pin holes 121 of the cover 120. At this time, the distal ends of the plurality of pins 224 cooperatively define one virtual surface contour. In the tactile feedback section 220, each of the plurality of pins 224 is fastened in a vertical direction to one end of each of driving elements 222, which respectively correspond to the pins 224, and the other end of each of the driving elements 222 is coupled to each of fastening members 221 which are disposed in a stepwise manner.

In the tactile feedback section 220 according to the present invention, constructed as mentioned above, as the driving elements 222 serving as a kind of piezoelectric elements are bent in one direction depending upon magnitudes of currents applied thereto, the plurality of pins 224 organically implement linear movement through the pin holes 121 to stimulate the finger of the user.

Referring to FIG. 2, the mouse interface system 200 according to the present invention is divided into the mouse section 210, which serves as a body for providing thermal feedback and tactile feedback, and a force generation section 230, which serves as a body for providing force feedback to the mouse section 210 by virtue of a quadric link mechanism 213.

The mouse section 210 comprises the thermal feedback section 100, the tactile feedback section 220, and the function buttons 211. The force generation section 230 comprises two motors 233 and two encoders 231 for adjusting the rotational velocities and the rotational angles of the two motors 233.

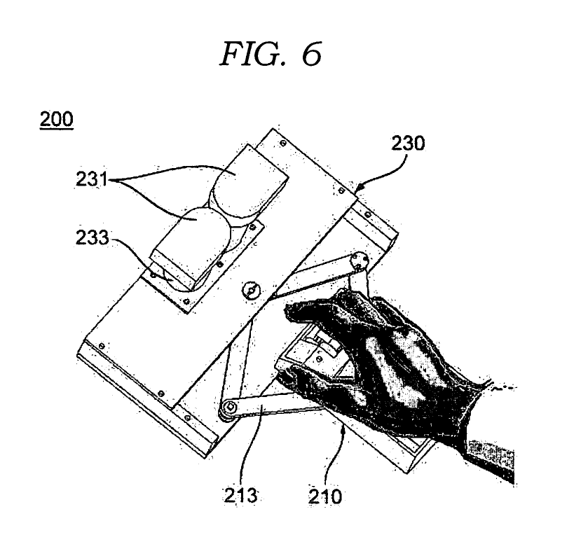

Hereafter, operations of the mouse interface system 200 according to the present invention will be described with reference to FIG. 6.

In order to use the mouse interface system 200, the user brings the thumb or the ring finger into contact with the cover 120 and the index finger and the middle finger into contact with the function buttons 211 provided at the upper end of the mouse section 210, and grasps the mouse section 210 serving as the system body by using the palm of the hand and the other fingers.

If the user moves the mouse section 210 while grasping the mouse section 210, the position of a cursor on the computer screen is changed. At this time, if the cursor passes over an imaged portion on the computer screen, having a visual nature and a shape, that is, a virtual object, the control section senses the passage of the cursor and converts the information of the virtual object into an electrical signal, and the information inputted into and converted in the control section is transmitted to each of the thermal feedback section 100, the tactile feedback section 220, and the encoders 231.

Then, in the mouse interface system 200 according to the present invention, the pins 224 of the tactile feedback section 220 organically project through the pin holes 121 in conformity with the surface quality of the imaged portion, and force feedback is provided to the mouse section 210 through the articulated motions of the quadric link mechanism 213. Consequently, the user is provided with the surface quality of the imaged portion upon which the cursor is currently positioned, through the grasping of the mouse section 210, and is also provided with the thermal feedback of the imaged portion through the finger contacting the cover 120 of the thermal feedback section 100.

While it has been explained herein that the thermal feedback section 100 and the tactile feedback section 220 of the mouse interface system 200 according to the present invention are formed on a side of the mouse section 210 to be contacted by the thumb or the ring finger of the user, it is to be noted that they can be installed in such a way as to overlap with the function buttons 240 to be contacted by the index finger or the middle finger of the user.

As is apparent from the above description, the mouse interface system according to the present invention provides advantages in that it can provide not only the roughness and the surface quality of a virtual object to the finger of a user through a plurality of pins of a tactile feedback section as in the conventional art, but also the cold and warm feelings of the virtual object to the finger of the user through a thermal feedback section.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A computer mouse interface system having a mouse section which includes a tactile feedback section arranged to stimulate a finger of a user through a plurality of pins so that the user can feel the nature of a virtual object displayed on a computer screen, the computer mouse interface system comprising:
a thermal feedback section arranged on a side of the mouse section to provide thermal information of the virtual object to the finger of the user, and comprising a thermoelement for discharging or absorbing heat in response to a control signal according to a temperature variation when a user's finger is contacted with the virtual object, a cover brought into contact with a surface of the thermoelement to receive heat from the thermoelement, and a cooler brought into contact with another surface of the thermoelement to absorb heat discharged from the thermoelement.

2. The computer mouse interface system according to claim 1, wherein at least one thermoelement which is brought into contact with the cover is arranged in the thermal feedback section.

3. The computer mouse interface system according to claim 1, wherein the thermal feedback section is installed to overlap with function buttons of the mouse section.

4. The computer mouse interface system according to claim 1 wherein the cover of the thermal feedback section is defined with a plurality of pin holes through which the plurality of pins of the tactile feedback section are respectively inserted.

5. The computer mouse interface system according to claim 1, wherein a temperature sensor is attached to the cover.

6. The computer mouse interface system according to claim 1, wherein the cooler is a water-cooling type cooler which uses cooling water as a cooling medium.

7. The computer mouse interface system according to claim 1, wherein the cooler is an air-cooling type cooler which uses air as a cooling medium.

8. The computer mouse interface system according to claim 2, wherein the thermal feedback section is installed to overlap with function buttons of the mouse section.

9. The computer mouse interface system according to claim 2, wherein the cover of the thermal feedback section is defined with a plurality of pin holes through which the plurality of pins of the tactile feedback section are respectively inserted.
